(19) United States
(12) Patent Application Publication
(10) Pub. No.: US 2014/0269468 A1
(43) Pub. Date: Sep. 18, 2014

(54) SYSTEMS AND METHODS FOR WIRELESS BAND SWITCHING

(71) Applicant: QUALCOMM INCORPORATED, San Diego, CA (US)

(72) Inventors: Zhanfeng Jia, Belmont, CA (US); Sandip HomChaudhuri, San Jose, CA (US); Shu Du, Milpitas, CA (US)

(73) Assignee: QUALCOMM INCORPORATED, San Diego, CA (US)

(21) Appl. No.: 13/831,010

(22) Filed: Mar. 14, 2013

(51) Int. Cl. H04W 24/02; H04W 52/02; H04W 72/04

(52) U.S. Cl. CPC H04W 24/02; H04W 72/04; H04W 52/0209
USPC 370/311; 370/329

(57) ABSTRACT

Systems and methods are disclosed for coordinating operation on multiple frequency bands between two or more multiple concurrent band (MCB) devices. The band switch protocols may include sending information on a second band after a communications link has been established on a first band. The receiving device may treat the transmission of the frame on the new band as a message to switch bands, such that the transmitting and receiving devices may conduct subsequent communications on the new band. Further, the band switch protocols allow for seamless operation over the band switch event. As a result, a frequency band having desired performance characteristics may be selected dynamically.

### FIELD OF THE PRESENT DISCLOSURE

This disclosure generally relates to wireless communication systems and more specifically to systems and methods for switching between frequency bands.

### BACKGROUND

The recent proliferation of devices employing wireless technologies has led to the increasing availability of devices featuring multiple wireless communication systems. In particular, wireless local area network (WLAN) protocols, such as those conforming to the 802.11 family of standards promulgated by the Institute of Electrical and Electronics Engineers (IEEE), may offer relatively high data rates over relatively long distances and offer an easy interface to existing network infrastructures. Depending upon the 802.11 standard being employed, the wireless communications may be carried on one or more frequency bands. For example, 802.11b/g/n networks may use a 2.4 GHz frequency band, 802.11a/n/ac networks may use a 5 GHz frequency band, 802.11j networks may use a 4.9 GHz frequency band, 802.11ad networks may use a 60 GHz band and legacy 802.11 networks may use a 900 MHz band.

Correspondingly, a WLAN may offer different performance characteristics depending upon the standard employed and the frequency band used. The choice of standard and band may involve striking a balance between a wide variety of performance indicators, including throughput, power efficiency, coverage, range, congestion and others. For example, a WLAN operating on the 2.4 GHz frequency band may suffer from increased interference due to the relatively crowded nature of this frequency, but may offer relatively efficient power usage. Further, a WLAN operating on the 60 GHz band may offer increased data rates at the expense of greater power consumption. Depending upon the application, different characteristics may be preferred. In some use cases, power efficiency may be paramount while in other situations, data rate may be more important.

In order to provide increased capacity and improve compatibility, dual band dual concurrent (DBDC) technologies have been developed using two independent transceivers to allow simultaneous operations over one or more frequency bands, such as the 2.4 and 5 GHz bands. More generally, a device having multiple independent transceivers capable of concurrent operation on multiple frequency bands may be known as a multiple concurrent band (MCB) device. Such devices may operate within an infrastructure WLAN as access points (APs) or stations (STAs) or may operate as peers in an ad hoc or peer-to-peer (P2P) network.

Given that performance characteristics vary depending upon the frequency band employed, it may be desirable for a MCB wireless communications device to dynamically switch between frequency bands to optimize one or more desired performance characteristics as warranted by a given situation. This disclosure achieves this and other goals.

### SUMMARY

This disclosure includes systems for wireless communication. For example, a wireless communications device may have a first transceiver configured to communicate with a first network node over a first frequency band, a second transceiver configured to communicate with the first network node over a second frequency band, and a band selection manager that may switch operation from the first frequency band to the second frequency band by transmitting over the second frequency band with the second transceiver after a communications link is established on the first frequency band. The band selection manager may apply association information corresponding to the communications link on the first frequency band to communications on the second frequency band.

In one aspect, the band selection manager may determine a performance characteristic associated with the second frequency band using the second transceiver while maintaining the communications link on the first frequency band prior to switching operation. Additionally, the band selection manager may switch operation to the second frequency band based on at least one from the group consisting of the determined performance characteristic, application information and operating condition.

In another aspect, the band selection manager may revert to operation on the first frequency band after transmitting a power save message on the second frequency band. Further, the band selection manager may switch operation to the second frequency band upon receiving an indication that data has been buffered for transmission by the first network node.

The systems of this disclosure may also include a wireless communications device having a first transceiver configured to communicate with a first network node over a first frequency band, a second transceiver configured to communicate with the first network node over a second frequency band, and a band selection manager that may detect a transmission from the first network node over the second frequency band after a communications link has been established on the first frequency band and switch operation from the first frequency band to the second frequency band upon receipt of the transmission on the second frequency band. Further, the band selection manager may apply association information corresponding to the communications link on the first frequency band to communications on the second frequency band. In addition, the band selection manager may revert to operation on the first frequency band after receiving a power save message on the second frequency band. Still further, the band selection manager may transmit a message suspending operation on the first frequency band when switching to the second frequency band.

This disclosure also includes methods for wireless communication between a first network node and a second network node. The first network node may have first and second transceivers and the second network node may have first and second transceivers such that the first and second network nodes may communicate over a first frequency band using the first transceivers and over a second frequency band using the second transceivers. For example, one method may include establishing a communications link between the first network node with the second network node over the first frequency band, sending a transmission from the first network node to the second network node over the second frequency band, and switching operation from the first frequency band to the second frequency based on reception of the transmission over the second frequency band. The method may also include applying association information corresponding to the communications link on the first frequency band to communications on the second frequency band.

In one aspect, the method may include determining a performance characteristic associated with the second frequency band using the second transceiver of the first network node while maintaining the communications link on the first frequency band prior to switching operation. As such, operation may be switched to the second frequency band based on at least one from the group consisting of the determined performance characteristic, application information and operating condition.

In another aspect, operation may revert to the first frequency band after transmitting a power save message with the first network node on the second frequency band. Further, operation may switch to the second frequency band on the first network node receiving an indication that data has been buffered for transmission by the second network node. Additionally, the second network node may transmit a message suspending operation on the first frequency band when switching to the second frequency band.

This disclosure also include non-transitory processor-readable storage media for operating a wireless communications device having a first transceiver configured to communicate with a first network node over a first frequency band and a second transceiver configured to communicate with the first network node over a second frequency band. In one aspect, the processor-readable storage medium may have instructions including code for establishing a communications link with a first network over the first frequency band and code switching operation from the first frequency band to the second frequency band by transmitting over the second frequency band. Further, the instructions may also include code for applying association information corresponding to the communications link on the first frequency band to communications on the second frequency band. Additionally, there may be code for determining a performance characteristic associated with the second frequency band using the second transceiver while maintaining the communications link on the first frequency band prior to switching operation. For example, there may be code for switching operation to the second frequency band based on at least one from the group consisting of the determined performance characteristic, application information and operating condition.

In one aspect, the instructions may include code for reverting to operation on the first frequency band after transmitting a power save message on the second frequency band. Further, the instructions may include code for switching operation to the second frequency band when receiving an indication that data has been buffered for transmission by the second network node.

In another aspect, the instructions may include code for establishing a communications link with a first network over the first frequency band and code switching operation from the first frequency band to the second frequency band after receiving a transmission on the second frequency band. Further, the instructions may include code for applying association information corresponding to the communications link on the first frequency band to communications on the second frequency band. In addition, the instructions may include code for reverting to operation on the first frequency band after receiving a power save message on the second frequency band. Still further, the instruction may include code for transmitting a message suspending operation on the first frequency band when switching to the second frequency band.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 schematically depicts a wireless communications system including an MCB station and a MCB access point, according to one embodiment;

FIG. 2 schematically depicts functional blocks of an MCB station, according to one embodiment;

FIG. 3 depicts upper layers and lower layers of a wireless communications protocol stack, according to one embodiment;

FIG. 4 depicts a sequence diagram showing a frequency band switch in response to a buffered traffic indication, according to one embodiment;

FIG. 5 depicts a sequence diagram showing a frequency band switch based on an operating condition, according to one embodiment;

FIG. 6 depicts a sequence diagram showing frequency band switches for station initiated traffic, according to one embodiment; and

FIG. 7 is a flowchart showing an exemplary routine for performing a band switch between MCB devices, according to one embodiment.

### DETAILED DESCRIPTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present invention and is not intended to represent the only exemplary embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

For purposes of convenience and clarity only, directional terms, such as top, bottom, left, right, up, down, over, above, below, beneath, rear, back, and front, may be used with respect to the accompanying drawings or particular embodiments. These and similar directional terms should not be construed to limit the scope of the invention in any manner and may change depending upon context. Further, sequential terms such as first and second may be used to distinguish similar elements, but may be used in other orders or may change also depending upon context.

Embodiments are described herein with regard to a wireless communications device and method of operation, which may include any suitable type of user equipment, such as a system, subscriber unit, subscriber station, mobile station, mobile wireless terminal, mobile device, node, device, remote station, remote terminal, terminal, wireless communication device, wireless communication apparatus, user agent, or other client devices. Further examples of a wireless communications device include mobile devices such as a cellular telephone, cordless telephone, Session Initiation Protocol (SIP) phone, smart phone, wireless local loop (WLL) station, personal digital assistant (PDA), laptop, handheld communication device, handheld computing device, satellite radio, wireless modem card and/or another processing device for communicating over a wireless system. Moreover, embodiments may also be described herein with regard to an access point (AP). An AP may be utilized for communicating with one or more wireless nodes and may be termed also be called and exhibit functionality associated with a base station, node, Node B, evolved NodeB (eNB) or other suitable network entity. An AP communicates over the air-interface with wireless terminals. The communication may take place through one or more sectors. The AP may act as a router between the wireless terminal and the rest of the access network, which may include an Internet Protocol (IP) network, by converting received air-interface frames to IP packets. The AP may also coordinate management of attributes for the air interface, and may also be the gateway between a wired network and the wireless network.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

Aspects of this disclosure include wireless communication over multiple frequency bands between at least two network nodes having MCB capabilities. As described above, operation on each frequency band may be associated with different performance characteristics, including throughput, power efficiency, coverage, range, congestion and others. Correspondingly, the techniques of this disclosure may be employed to allow the MCB devices to dynamically select among the available bands to emphasize one or more desired performance characteristics.

To help illustrate the systems and methods of this disclosure, an exemplary wireless communication system 100 is shown in FIG. 1, including MCB station (STA) 102 and MCB access point (AP) 104. Although this embodiment is described in the context of an infrastructure WLAN, suitable MCB devices may be configured in any network topology, including an ad hoc network or peer to peer network, such as Wi-Fi Direct™. Further, in this embodiment, MCB STA 102 and MCB AP 104 are shown to include three independent transceivers, allowing for concurrent operation on the 2.4 GHz band, the 5 GHz band and the 60 GHz band. In other embodiments, the techniques of this disclosure may be applied to any communications between MCB devices having two or more concurrent transceivers operating on independent frequency bands.

Additional details regarding one embodiment of MCB STA 102 are depicted as high level schematic blocks in FIG. 2. Other MCB devices acting in other roles, such as MCB AP 104, may be similarly configured. Generally, MCB STA 102 may employ an architecture in which the lower levels of the WLAN protocol stack are implemented in firmware and hardware of WLAN transceiver 202. As shown, 2.4 GHz transceiver 202 includes media access controller (MAC) 204 that performs functions related to the handling and processing of 802.11 frames of data including verification, acknowledgment, routing, formatting and the like. Incoming and outgoing frames are exchanged between MAC 204 and physical layer (PHY) 206, which as shown includes the functions of modulating the frames according to the relevant 802.11 protocol as well as providing the analog processing and RF conversion necessary to provide transmission and reception of wireless signals. Further, MCB STA 102 may also include 5 GHz transceiver 208 having MAC 210 and PHY 212 and 60 GHz transceiver 214 having MAC 216 and PHY 218. In the depicted embodiment, 2.4 GHz transceiver 202, 5 GHz transceiver 208 and 60 GHz transceiver 214 each have an associated antenna, antennas 220, 222 and 224, respectively. However, as desired and depending upon the wireless protocols employed, one or more antennas may be shared between the transceivers using switching techniques known in the art. Likewise, some or all elements of the respective transceivers may be collocated on a common system, (e.g., on the same circuit board or on distinct circuit boards within the same system, or may be embedded on the same integrated circuit as in a system on a chip (SoC) implementation).

MCB STA 102 also includes host CPU 226 configured to perform the various computations and operations involved with the functioning of MCB STA 102. Host CPU 226 is coupled to 2.4 GHz transceiver 202, 5 GHz transceiver 208 and 60 GHz transceiver 214 through bus 228, which may be implemented as a peripheral component interconnect express (PCIe) bus, a universal serial bus (USB), a universal asynchronous receiver/transmitter (UART) serial bus, a suitable advanced microcontroller bus architecture (AMBA) interface, a serial digital input output (SDIO) bus, or other equivalent interface. As shown, MCB STA 102 may include band selection manager 230 implemented as processor-readable instructions stored in memory 232 that may be executed by CPU 226 to coordinate operation of 2.4 GHz transceiver 202, 5 GHz transceiver 208 and 60 GHz transceiver 214 according to the techniques of this disclosure. As described below, band selection manager 230 may be configured to assess channel conditions associated with 2.4 GHz transceiver 202, 5 GHz transceiver 208 and 60 GHz transceiver 214 and dynamically switch the transceivers while communicating with MCB AP 104 or may be configured to interpret information transmitted on a new band as a band switch message and transfer operation to the transceiver corresponding to the new band.

FIG. 3 illustrates a more detailed representation of aspects of the WLAN protocol stacks, particularly with regard to the logical division of the upper protocol layers implemented as software processes operating in host CPU 226 and the lower protocol layers implemented of 2.4 GHz transceiver 202, 5 GHz transceiver 208 and 60 GHz transceiver 214. As shown, upper layers implemented in host CPU 226 may include application layer 302 and internet protocol (IP) stack 304. Packaged data may be exchanged between IP stack 304 and the respective MAC and PHY layers of 2.4 GHz transceiver 202, 5 GHz transceiver 208 and 60 GHz transceiver 214 through band selection manager 230. For example, when the 2.4 GHz band is selected, band selection manager may route packets from IP stack 304 to and from MAC 204 and PHY 206 of 2.4 GHz transceiver 202. Similarly, when the 5 GHz band is selected, band selection manager may route packets from IP stack 304 to and from MAC 210 and PHY 212 of 5 GHz transceiver 208 and when the 60 GHz band is selected, band selection manager may route packets from IP stack 304 to and from MAC 216 and PHY 218 of 60 GHz transceiver 214. Band selection manager 230 may act as an intermediary between the lower layers of 2.4 GHz transceiver 202, 5 GHz transceiver 208 and 60 GHz transceiver 214 and the upper layers, such that the choice of transceiver may be substantially transparent from the perspective of application layer 302.

Band switch events may be coordinated between MCB devices by granting band switching initiative to one of the devices, such that the device with the initiative may commence the band switch process unilaterally. According to the band switch protocols of this disclosure, communications from a device with band switching initiative matching defined criteria may be interpreted to carry an implicit band switch message. In one aspect, a first device with band switching initiative sharing an established communications link with a second device on a first band may trigger a switch to a second band by sending a frame on the second band. These protocols represent a reduction in overhead as compared to conventional band switching, since no handshake or other exchange of management frames is required on the first band. Further, the sending of the frame on the second band provides the necessary timing information to coordinate the band switch without the need to explicitly define a transition time. Band selection manager 230 may be configured to perform the appropriate actions depending upon whether the MCB device has band switching initiative, either by transmitting information on a new band to trigger the band switch or by interpreting information received on a new band as a band switch message and switching operation to the new band. In both situations, band selection manager 230 routes subsequent information over the transceiver corresponding to the new band.

Band switching initiative may be granted by default based upon the role of the device within the network. For example, in an infrastructure network, the initiative may be granted to one of either the station or the access point. As another example, in a peer to peer network, such as a Wi-Fi Direct™ network, band switching initiative may be granted by default to one of either the group owner (GO) or the peer. By establishing default band switching initiative with a given role, additional negotiation between devices on the network may not be required as each participating device may interpret band switch messages appropriately based on the role of the device.

Alternatively, or in addition, devices in a network may explicitly establish band switching initiative among themselves or override a default initiative such that subsequent band switch messages will be interpreted correctly. Band switching initiative may be established during an association process or at any desired point thereafter. In one aspect, network topologies lacking defined roles, such as ad hoc networks, may employ such explicit band switching initiative assignment processes.

Band switch protocols of this disclosure include sending a frame with an MCB device having band switching initiative on a new band. The receiving device may treat the transmission of the frame on the new band as a message to switch bands, such that the transmitting and receiving devices may conduct subsequent communications on the new band. If desired, a handshake exchange may be performed on the new band. Further, although the embodiments are discussed with respect to all the traffic being exchanged by an MCB device, these techniques may be applied to individual data streams. As a result, performance may be tailored based on different traffic classes or other suitable criteria.

In a further aspect, the MCB device with band switching initiative may switch bands based on any suitable criteria. For example, since the device with band switching initiative is an MCB device, the device may periodically scan the other frequency bands without disrupting communications over the current frequency band in order to determine performance information regarding the other frequency bands, such as signal strength and traffic load. Likewise, the MCB device may also use application information regarding performance requirements, such as a desired level of throughput or quality of service (QoS) to determine whether a band switch is warranted. Still further, the MCB device may also use a suitable operating condition, such as available battery power, as a basis for making a band switch. The MCB device with band switching may use any combination of these factors to determine whether to trigger a band switch.

To reduce overhead associated with a band switch, each MCB device may be configured to share security, QoS information and/or other relevant association parameters between transceivers, which termed “association information” for the purposes of this disclosure. Accordingly, the MCB device with band switching initiative transmitting the frame on the new band to perform the band switch may apply the association information determined for the old band to subsequent communications on the new band. Correspondingly, after identifying the device transmitting the band switch frame, the receiving device may also apply the appropriate association information.

Examples are described below in the context of wireless communication system 100 including MCB STA 102 and MCB AP 104, wherein band switching initiative has been assigned by default or explicitly assigned to MCB 102. However, as noted, in other embodiments, the access point may be granted band switching initiative by default or different network topologies may be employed. The device having band switching initiative may be configured to trigger a band switch to a new band to take advantage of one or more desired performance characteristics associated with the new band, such as power efficiency, coverage, range, congestion or the like.

In one embodiment, wireless communication system 100 may be configured to automatically employ a frequency band associated with power efficiency, such as the 2.4 GHz band, for baseline level communications and to dynamically switch to another frequency band as warranted, based on any desired criteria. FIG. 4 illustrates a sequence diagram representing one example embodiment including MCB STA 102 and MCB AP 104. During operation in the role of an access point, MCB AP 104 may concurrently manage three independent infrastructure networks using a 2.4 GHz transceiver, a 5 GHz transceiver and a 60 GHz transceiver. MCB STA 102 may initially be in a power save mode operating on the 2.4 GHz band. While in power save mode, MCB STA 102 periodically awakens to receive beacon transmissions from MCB AP 104 that may include an indication that data has been buffered for MCB STA 102, such as a beacon having a traffic indication map (TIM) information element (IE).

In this example, MCB STA 102 may be configured to switch frequency bands for all data transfers in order to use a frequency band offering an increased data rate, such as the 5 GHz band. As shown, MCB STA 102 may send a band switch message on the new band to trigger the band switch. The band switch message may be any suitable frame. For example, in the context of exiting from power save mode, MCB STA 102 may send a PS-POLL frame or an NDATA frame having the power management (PM) bit set to zero on the 5 GHz frequency band. MCB AP 104 may be configured to interpret the receipt of the frame on the new band as an implicit band switch message. To complete the band switch, MCB AP 104 may suspend operation on the 2.4 GHz band by sending an appropriate frame, such as a frame with the more data (M) bit set to zero. MCB AP 104 may then transmit the buffered data on the 5 GHz band as shown.

Once the buffered data has been delivered, MCB STA 102 may suspend operation by sending a frame with the PM bit set to one, indicating a return to power save mode. Since wireless communication system 100 may be configured to automatically revert to the more power efficient 2.4 GHz band, no further communication regarding band switch may be necessary. MCB STA 102 may operate in power save mode on the 2.4 GHz band, periodically awakening to receive beacons sent by MCB AP 104. Alternatively, MCB STA 102 may actively trigger a band switch by sending an appropriate frame on a new band.

Another example of band switching involving MCB STA 102 and MCB AP 104 is shown in the sequence diagram of FIG. 5. Here, MCB STA 102 may also automatically reside on the 2.4 GHz frequency band to optimize power efficiency and awaken to receive beacon transmissions from MCB AP 104. Upon receipt of a TIM beacon indicating there is buffered data ready for transmission, MCB STA 102 may respond conventionally on the 2.4 GHz band, such as with a PS-POLL frame or an NDATA frame with the PM bit set to zero. MCB AP 104 may then begin to deliver the data over the 2.4 GHz band. In this embodiment, MCB STA 102 may be configured to be select among frequency bands based on one or more factors including determined performance criteria, application information, operating condition or the like. For example, MCB STA 102 may switch to a frequency band offering a higher data rate when the amount of buffered data exceeds a threshold. Accordingly, after a given period of time or after receipt of a given number of frames, MCB STA 102 may send a band switch message on the new band to trigger the band switch. The band switch message may be any suitable frame, such as a PS-POLL frame or an NDATA frame with the PM bit set to zero.

The transmit queues for the MCB AP 104 may be coordinated between the involved transceivers to help ensure a seamless transition. For example, MCB AP 104 may treat the receipt of the band switch frame from MCB STA 102 as the time point to switch to the new frequency band. All frames in the transmit queue for the old frequency band may be transferred to the transmit queue for the new frequency band. Once the last frame sent on the old frequency band is acknowledged, MCB AP 104 may complete the band switch and suspend operation on the 2.4 GHz band by sending an appropriate frame, such as a frame with the M bit set to zero. MCB AP 104 may then continue transmitting the buffered data on the 5 GHz band as shown. Once the buffered data has been delivered, MCB STA 102 may suspend operation by sending a frame on the 5 GHz band with the PM bit set to one, indicating a return to power save mode on the 2.4 GHz band.

An equivalent protocol for performing a band switch may be implemented for transmissions originating with MCB STA 102, which are illustrated with regard to the sequence diagram of FIG. 6. For small, infrequent or low priority transfers, MCB STA 102 may be configured to transmit on the 2.4 GHz band as shown. Based upon criteria such as the examples given above, MCB STA 102 may determine that a performance characteristic associated with a different frequency band is desired. As shown, MCB STA 102 may effect the switch by reconfiguring the involved transmit queues so that all frames subsequent to the switch are routed over the 5 GHz band. Likewise MCB AP 104 may treat the receipt of a frame on the 5 GHz band as a band switch message and conduct any future exchanges or acknowledgements on that band, until another switch is signaled.

In a further aspect, also illustrated in FIG. 6, MCB STA 102 and MCB AP 104 may conduct a handshake exchange to perform the band switch. As shown, MCB STA 102 may initiate a band switch from the 5 GHz band to the 60 GHz band by sending a request frame on the 60 GHz band. Upon receipt of the request frame, MCB AP 104 may send a response frame on the 60 GHz band. After receiving the response frame, MCB STA 102 may then transmit data over the 60 GHz band.

To help illustrate the techniques of this disclosure with regard to performing a band switch procedure between MCB devices, an exemplary routine is represented by the flowchart of FIG. 7. Beginning with step 702, a first MCB device, such as MCB STA 102, and a second MCB device, such as MCB AP 102, may establish a communications link on a first frequency band. The MCB device having the band switching initiative may trigger a band switch by transmitting information on a second frequency band in step 704. For example, MCB STA 102 may have band switching initiative by virtue of its role as station in an infrastructure network and send a suitable PS POLL or NDATA frame on the second frequency band. According to the band switching protocols of this disclosure, the receiving MCB device, such as MCB AP 104, may be configured to interpret a transmission on a new frequency band as a message to switch operation to the new band. Correspondingly, MCB AP 104 may switch operation to the second frequency band in step 706. As represented by step 708, MCB STA 102 and MCB AP 104 may apply association information determined with regard to the communications link on the first frequency band to communications over the second frequency band. Further, if the MCB device receiving the band switch message was actively transmitting over the first frequency band, operation may be suspended on the first frequency band in step 710. For example, MCB AP 104 may be signaling and transmitting buffered data as part of a power save scheme when MCB STA 102 sends the band switch message. In turn, MCB AP 104 may send an appropriate NDATA frame to suspend operation on the first frequency band.

Described herein are presently preferred embodiments. However, one skilled in the art will understand that the principles of this disclosure can be extended easily with appropriate modifications to other applications.

What is claimed is:

1. A wireless communication device, comprising:
a first transceiver configured to communicate with a first network node over a first frequency band;
a second transceiver configured to communicate with the first network node over a second frequency band; and
a band selection manager configured to switch operation from the first frequency band to the second frequency band by transmitting over the second frequency band with the second transceiver after a communications link between the wireless communication device and the first network node is established on the first frequency band.

2. The wireless communications device of claim 1, wherein the band selection manager is further configured to apply association information corresponding to the communications link on the first frequency band to transmissions on the second frequency band.

3. The wireless communications device of claim 1, wherein the band selection manager is further configured to determine a performance characteristic associated with the second frequency band using the second transceiver while maintaining the communications link on the first frequency band prior to switching operation.

4. The wireless communications device of claim 3, wherein the band selection manager switches operation to the second frequency band based, at least in part, on at least one from the group consisting of the determined performance characteristic, application information, operating condition of the first frequency band and operating condition of the second frequency band.

5. The wireless communications device of claim 1, wherein the band selection manager is further configured to revert to operation on the first frequency band after transmitting a power save message on the second frequency band.

6. The wireless communications device of claim 1, wherein the band selection manager is configured to switch operation to the second frequency band upon receiving an indication that data has been buffered for transmission by the first network node.

7. A wireless communications device, comprising:
a first transceiver configured to communicate with a first network node over a first frequency band;
a second transceiver configured to communicate with the first network node over a second frequency band; and
a band selection manager configured to:
detect a transmission from the first network node over the second frequency band after a communications link has been established on the first frequency band; and
switch operation from the first frequency band to the second frequency band upon receipt of the transmission on the second frequency band.

8. The wireless communications device of claim 7, wherein the band selection manager is further configured to apply association information corresponding to the communications link on the first frequency band to transmissions on the second frequency band.

9. The wireless communications device of claim 7, wherein the band selection manager is further configured to revert to operation on the first frequency band after receiving a power save message on the second frequency band.

10. The wireless communications device of claim 7, wherein the band selection manager is further configured to transmit a message suspending operation on the first frequency band when switching to the second frequency band.

11. A method for wireless communication between a first network node and a second network node, wherein the first network node has first and second transceivers and the second network node has first and second transceivers such that the first and second network nodes may communicate over a first frequency band using the first transceivers and over a second frequency band using the second transceivers, comprising:
establishing a communications link between the first network node and the second network node over the first frequency band;
sending a transmission from the first network node to the second network node over the second frequency band; and
switching operation from the first frequency band to the second frequency band upon sending the transmission over the second frequency band.

12. The method of claim 11, further comprising applying association information corresponding to the communications link on the first frequency band to communications on the second frequency band.

13. The method of claim 11, further comprising determining a performance characteristic associated with the second frequency band using the second transceiver of the first network node while maintaining the communications link on the first frequency band prior to switching operation.

14. The method of claim 13, further comprising switching operation to the second frequency band based, at least in part, on at least one from the group consisting of the determined performance characteristic, application information, operating condition of the first frequency band and operating condition of the second frequency band.

15. The method of claim 11, further comprising reverting to operation on the first frequency band after transmitting a power save message with the first network node on the second frequency band.

16. The method of claim 11, wherein operation switches to the second frequency band on the first network node receiving an indication that data has been buffered for transmission by the second network node.

17. The method of claim 11, further comprising transmitting a message suspending operation on the first frequency band with the second network node when switching to the second frequency band.

18. A non-transitory processor-readable storage medium for operating a wireless communications device having a first transceiver configured to communicate with a first network node over a first frequency band and a second transceiver configured to communicate with the first network node over a second frequency band, the processor-readable storage medium having instructions thereon, when executed by a processor of the wireless communications device, cause the device to:
establish a communications link with a first network over the first frequency band; and
switch from the first frequency band to the second frequency band by transmitting over the second frequency band.

19. The storage medium of claim 18, further comprising instructions, when executed by the processor, to cause the device to apply association information corresponding to the communications link on the first frequency band to transmissions on the second frequency band.

20. The storage medium of claim 18, further comprising instructions, when executed by the processor, to cause the device to determine a performance characteristic associated with the second frequency band using the second transceiver while maintaining the communications link on the first frequency band prior to switching operation.

21. The storage medium of claim 20, further comprising instructions, when executed by the processor, to cause the device to switch to the second frequency band based, at least in part, on at least one from the group consisting of the determined performance characteristic, application information, operating condition of the first frequency band and operating condition of the second frequency band.

22. The storage medium of claim 18, further comprising instructions, when executed by the processor, to cause the device to revert to operation on the first frequency band after transmitting a power save message on the second frequency band.

23. The storage medium of claim 18, further comprising instructions, when executed by the processor, to cause the device to switch operation to the second frequency band when receiving an indication that data has been buffered for transmission by the second network node.

24. A non-transitory processor-readable storage medium for operating a wireless communications device having a first transceiver configured to communicate with a first network node over a first frequency band and a second transceiver configured to communicate with the first network node over a second frequency band, the processor-readable storage medium having instructions thereon, when executed by a processor, to cause the device to:
establish a communications link with a first network over the first frequency band; and
switch operation from the first frequency band to the second frequency band after receiving a transmission on the second frequency band.

25. The storage medium of claim 24, further comprising instructions, when executed by the processor, to cause the device to apply association information corresponding to the communications link on the first frequency band to transmissions on the second frequency band.

26. The storage medium of claim 24, further comprising instructions, when executed by the processor, to cause the device to revert to operation on the first frequency band after receiving a power save message on the second frequency band.

27. The storage medium of claim 24, further comprising instructions, when executed by the processor, to cause the device to transmit a message suspending operation on the first frequency band when switching to the second frequency band.
